(19) United States
(12) Patent Application Publication
(10) Pub. No.: US 2015/0104770 A1
(43) Pub. Date: Apr. 16, 2015

(54) SYSTEMS AND METHODS FOR PERSONALIZED INCENTIVE-BASED HEALTH SUPPORT

(71) Applicant: Health Dialog Services Corporation, Boston, MA (US)

(72) Inventors: Marc S. Agger, Boston, MA (US); Amy Allen, Boston, MA (US); David Veroff, Boston, MA (US)

(21) Appl. No.: 14/511,797

(22) Filed: Oct. 10, 2014

Related U.S. Application Data
(60) Provisional application No. 61/890,058, filed on Oct. 11, 2013.

(51) Int. Cl. G09B 5/00; G06F 19/00

(52) U.S. Cl. CPC G09B 5/00; G06F 19/3475
USPC 434/236

(57) ABSTRACT

Systems and methods for creating a personalized health program are disclosed. The systems and methods may use a personalization engine to accept health data and condition specific actions and to output a list of at least one personalized action. The personalized actions may help patients in creating and sustaining behaviors to help improve health and productivity and lower healthcare costs. Such personalized health programs may use incentives to make such programs more effective.

### CROSS-REFERENCE TO RELATED APPLICATIONS

This Patent Application claims priority to U.S. Provisional Patent Application No. 61/890,058 filed Oct. 11, 2013 entitled “SYSTEMS AND METHODS FOR PERSONALIZED INCENTIVE-BASED HEALTH SUPPORT.” The disclosure of the prior Application is considered part of and is incorporated by reference in this Patent Application.

### BACKGROUND

Institutions often want to support their members' health and well-being. The reasons for the support may vary from one institution to another. For example, one employer may want to reduce direct health costs and improve employee productivity while a university may want to improve student morale. Some institutions have created health incentive programs, offering incentives to encourage their members to lead healthier lifestyles, participate in health and wellbeing programs, or otherwise act to maintain or improve their health.

Personalizing such a health incentive program may make it more effective. Incentives that encourage a sedentary participant to become more active may be too easily met by a casual runner, and incentives that encourage a casual runner to become a regular runner may present too great a challenge to a sedentary participant. While providing personalized experiences which empower individuals to take control of their health and wellness is a laudable goal, the specific mechanisms that can bring this experience to a diverse customer base with a wide range of health conditions is a daunting objective.

The backbone of personalization is built from the concept of consumer segmentation, where customers are placed into distinct groups based on one or more combination of market related characteristics. Product marketing is then customized to these market segments, creating a more personalized experience. The concept of a single scheme to segment health care customers across hundreds of medical conditions, each potentially with multiple stages of disease, each with unique interactions across multiple comorbidities, compounded by behaviors, attitudes and social influences requires a complex application of traditional consumer segmentation. While traditional approaches and methods to segment consumers may have applicability to health care, the complexity and personal nature of health limits this usefulness for achieving desired outcomes.

Statistical methods such as association rules mining (i.e. market basket analysis), cluster analysis, and neural networks can be useful tools to define a series of relatively distinct consumer classes. However, the complexity and the personal nature of health care require many times more segments than is feasible with these traditional segmentation methods. One alternative approach to this problem is to create a relatively small and manageable number of clinical segments. The down side of this approach is that the resulting groupings will be generic in nature and will have limited value and resonance with the individual consumer. At the other end of the spectrum, having a large number of detailed segmentation groups creates the risk for false identification which can lead to long lasting negative consequences with the customer relationship. Another approach to creating a large set of granular clinical segments is to tactically attack these as a series of smaller segmentation schemes grouped by condition. While this approach can appear to make the work seem more manageable, the individual efforts are likely to be fragmented in nature and incompatible across conditions and result in a complex set of segmentation rules that degenerate over time and have increasingly questionable value.

There is a need for a more effective personalized health program. There is also a need for a clinical segmentation scheme based, at least in part, on clinical input expertise as well as on statistical associations, and based on rules that are generalizable across conditions. There is a need for seamless segmentation schema across the entire spectrum of care, and generalizable principles for defining stages of disease in a common format across disease pathways to generate clinical segments for 100% of the population.

### SUMMARY

The systems, methods and devices of this disclosure each have several innovative aspects, no single one of which is solely responsible for the desirable attributes disclosed herein. In one innovative aspect of the subject matter described in this disclosure can be implemented in a computer-implemented method for creating a personalized health program, including receiving information about a member, updating a member condition table with the information, creating a list of actions by combining the information in the member condition table with disease action data, organizing the list of at least one action, generating an action plan including the at least one action, and presenting the action plan to the member.

In some implementations, organizing the list of at least one action includes assigning points to prioritize the at least one action. In some implementations, receiving information about a member includes receiving at least one health vision from the member. The health vision may be selected from a list of health visions. In some implementations, the computer-implemented method for creating a personalized health program further includes re-calculating the points to account for the health vision.

In some implementations, generating the action plan includes associating at least one incentive with the at least one action. In some implementations, the at least one action includes a personalized health challenge. In some implementations, the computer-implemented method for creating a personalized health program further includes receiving a population health goal, and generating the action plan based, at least in part, on the population health goal. In some implementations, the information includes at least one of claims data, a health risk assessment data, and biometric data. In some implementations, the population health goal is to reduce the medical costs associated with a plurality of employees or members of a health plan. In some implementations, the population health goal is to increase the number of employees or members who participate in a health program. In some implementations, the population health goal is to increase the productivity of the plurality of employees or members. In some implementations, the at least one incentive is a gift card. In some implementations, the at least one incentive is a reduction in a health care premium.

Another innovative aspect of the subject matter described in this disclosure can be implemented in a system for providing a personalized health program, including a personalization engine configured to: receive a member condition table comprising member health data, receive condition specific actions, identify a list of at least one disease based on the member health data and associate at least one condition specific action with the at least one disease, and output a list of at least one personalized action. The system for providing a personalized health program may also include a user interface coupled to the personalization engine for accepting input data from the member, and presenting the at least one personalized action to the member.

In some implementations, the personalization engine is further configured to receive at least one health aspiration. In some implementations, a user chooses the at least one health aspiration from a list of health aspirations presented on the user interface.

In some implementations, the personalization engine is further configured to receive clinical weighting data. In some implementations, the clinical weighting data is used by the personalization engine to weight the relative importance of a plurality of disease stages. In some implementations, the personalization engine periodically monitors member health data and updates the list of at least one disease based on new member health data.

In some implementations, the personalization engine further comprises a prioritization engine for prioritizing the list of at least one personalized action. In some implementations, the prioritization engine prioritizes the list of at least one personalized action by emphasizing a more clinically efficacious action over a less clinically efficacious action.

In some implementations, the system includes an incentive management tool configured to associate at least one incentive with each of the at least one personalized actions. In some implementations, the list of at least one personalized action comprises at least one action related to a smoking cessation program. In some implementations, the list of at least one personalized action comprises at least one action related to a weight loss program.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is a block diagram of a personalization engine system, according to an illustrative implementation;

FIG. 2A is a table of actions, according to an illustrative implementation;

FIG. 2B is a table of pathway stage values, according to an illustrative implementation;

FIG. 3 is a table of pathway stage domain weight values, according to an illustrative implementation;

FIG. 4 is a table of pathway stage sub-domain weight values, according to an illustrative implementation;

FIG. 5 is a table of health vision sub-domain weight values, according to an illustrative implementation;

FIG. 6 is a flow chart of a process for operating a personalization engine, according to an illustrative implementation; and

FIG. 7 is a flow chart a process for using a personalization engine, according to an illustrative implementation.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways.

The systems and methods described herein relate to a personalized program that supports patients in creating and sustaining behaviors to help improve health and productivity and lower healthcare costs. Such personalized health programs may use incentives to make such programs more effective. Such methods and systems may receive health information about a participant. Health information may include claims data, specific health purchasing information, health risk assessments (HRA), or biometric information (such as height, weight, cholesterol levels, or other suitable information), and may be received from the participant or from a source the participant has permitted to share such information, e.g., health insurance company, physician, or activity monitoring device or programs (such as FitBit or RunKeeper). These health factors may be used to assign and track patients along a continuum of disease progression or tracking health status of individuals who may be healthy and may be likely to increase their risk of a health problem. As used herein, the term disease is broadly used to refer to any medical condition, illness, injury or any other ailment. Each stage of disease may be associated with a predefined plan of care which has been designed to meet evidence based care priorities for that particular stage of disease. Stage of disease is used herein as a concept related to differential standards of care according to length of episode, severity of symptoms and complexity of treatments. As the patient progresses to a new stage of disease, the plan of care continuously evolves with changing care priorities.

A participant may also provide one or more of the participant's health goals and health aspirations to such systems and methods by choosing a goal from a list of predetermined goals (e.g., “I want to see my grandchildren grow up,” “I want to worry less about my health,” “I want to climb two flights of stairs without feeling short of breath,” or other suitable goals), or, in some implementations, by describing the goal in the participant's own words. For example, the user interface 114 may present one or more choices to a member to determine that member's health aspirations

A personalization engine may be used to analytically select individually-prioritized recommended actions that individuals may select based on their health aspirations and personal risk factors. The personalization engine may be implemented on a processor, microchip or other suitable computer-implemented medium. The personalization engine may incorporate a variety of factors such as 1) information about an individual, 2) socio-demographic information, 3) employer goals, and 4) individual's responses to aspirational questions in order to provide a customized list of recommended actions. The personalization engine may scan customer, e.g., program participant, data for key bits of information which are used as potential indicators of disease stage and state. Identified data points are brought into the personalization engine and evaluated against what is known about the customer. For example, if the personalization engine determines that an individual is a smoker, a recommended action may include a smoking cessation program. If, for example, the data point adds new information within the context of what is already known about the customer, the personalization engine may trigger a change in the disease or disease state tracked in the system and/or a change in the personalized action plan for that member. The system may continuously monitor the source data and may update the disease status with each new cycle of information. The personalization engine may determine an evidence-based action plan which provides key goals that reflect the most important care issues and challenges facing the customer. Each stage of the disease may be associated with a default hierarchy of prioritized goals and actions that can be adapted by further personalization.

The prioritized goals and actions may be expressed through specific challenges with differential point values through a member portal. The point values may be connected to incentives. As an illustrative example, a healthy participant might be challenged to run a 5K, and will earn fifty points toward a $100 gift card; a sick participant might be challenged to walk ten minutes a day for two weeks, and earn 200 points toward the same reward. To extend the illustrative example, the healthy participant may also be challenged to join a sick participant on several walks, and thereby encourage wider participation in the program.

Completion of some health challenges may be self-reported, such as a user reporting that she completed a ten-mile run. Completion of other health challenges may be based on receiving new health information, such as a challenge to get an annual physical examination, or to reduce the participant's resting blood pressure.

Particular implementations of the subject matter described in this disclosure can be implemented to realize one or more of the following potential advantages. The disclosed systems and methods may be highly intuitive to patients and providers, and serve as relatively straightforward ways to serve up highly structured health actions that help to promote wellness and slow disease progression. The disclosed systems and methods provide the ability to segment 100% of the population with personalized, timely and contextual health and wellness interventions. Because the disclosed systems and methods take into consideration both stage of an individual disease and disease states, e.g., for comorbid conditions, the systems are able to serve up individual recommendations that meet the qualifications for all conditions. For example, a heavily restrictive diet for someone who is considered obese may not be recommended if that person is also in a late stage of kidney or heart disease. Similarly, an exercise program for someone who is overweight needs to be sensitive to the fact that the patient has pain or osteoarthritis of the back, knee or hip. Because the disclosed systems and methods take into consideration both stage of an individual disease and diseases states, the disclosed systems can support recommendations that are appropriate even under these more complicated clinical circumstances.

Furthermore, the disclosed systems and methods may provide highly personalized interventions using direct-to-consumer programs. For example, the disclosed systems and methods may include a smoking cessation program that would identify each individual's specific reason for wanting to quit smoking, the health issues that are affected by their smoking as well as the subsequent specific benefits they would receive by quitting smoking, both of which would contribute to a highly motivating and personalized quit plan and subsequent support. Unlike many existing programs, the disclosed systems and methods tap into individuals' intrinsic motivation, and such a personalized intervention would lead to greater adoption and engagement.

Another example may include a weight loss program. Applying the disclosed systems and methods of intervention to a weight loss program would also deliver a highly personalized intervention that considers each individual's health status, conditions that could affect their weight loss approach, and weight loss strategies that may be more effective for their specific situation.

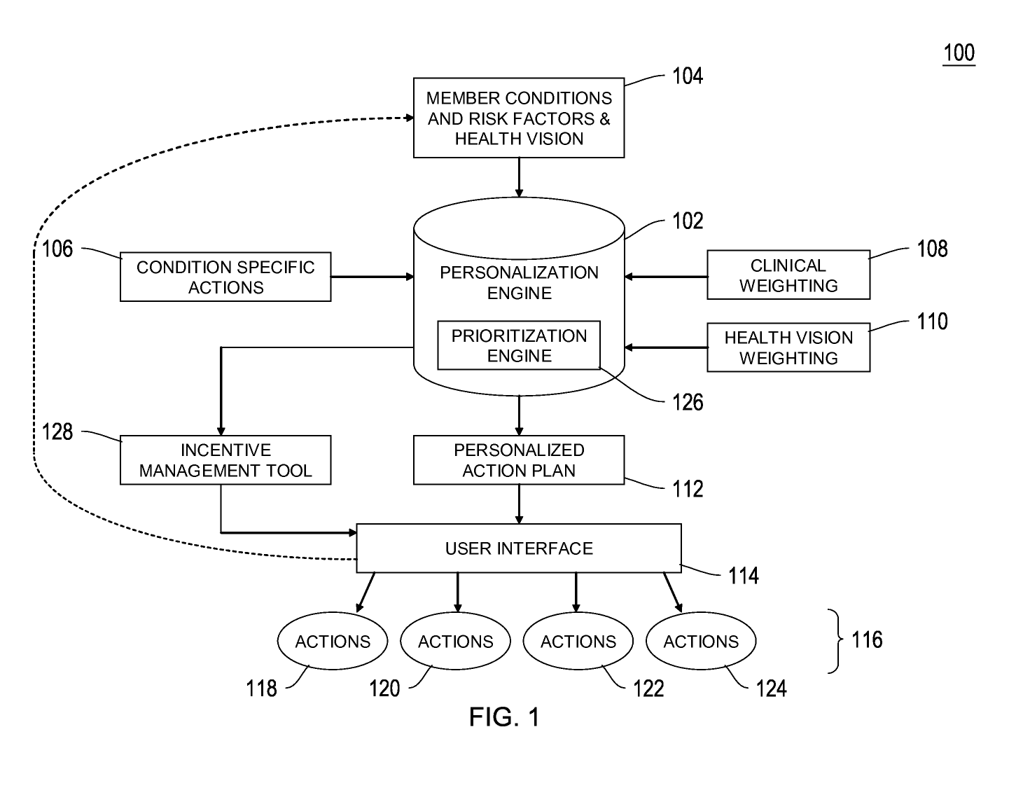

FIG. 1 is an illustrative block diagram of personalization engine system 100 including a personalization engine 102. The personalization engine 102 may include a prioritization engine 126. The personalization engine 102 may accept data from one or more sources and generate an output 112 for a member. The personalization engine system may be run using a processor, and data may be stored on a computer readable medium or any other suitable computer hardware known to those having ordinary skill in the art. The personalization engine system 100 also includes inputs 104, 106, 108, 110, incentive management tool 128, prioritization engine 126 and user interface 114. User interface 114 may output actions 118, 120, 122, and 124 as part of an action plan 116. User interface 114 may be any type of user interface known to those of skill in the art. For example, user interface 114 may include a web portal, a smart phone app or an in-store kiosk. Operation of the personalization engine 102 may include a multi-step process that first associates specific actions with specific disease states and risk factors. The specific recommended actions may include internal knowledge-based actions, such as education (e.g., watching a video to learn about how to exercise with knee pain), or physical actions such as exercise to address knee pain. For example, the personalization engine 102 may consider a member's disease state and evaluate the member's condition and where they are within a disease trajectory and associate a series of actions based on the member's conditions and where they are within the disease trajectory. In certain embodiments, differential points may be assigned based on a generalized framework of stage-specific clinical priorities. A secondary weighting process may also be applied based, at least in part, on a user-selected “vision” or “aspiration”. Actions and weights may be passed to a user-facing logical process. This process may parse out actions based on behavior change theories such as small steps and a mix of internalized and externalized behavior change actions. Using these inputs and one or more internal algorithms, the personalization engine 102 can output 112 information that is very specific to a member's disease, including where the member is within a disease trajectory. Furthermore, the personalization engine system 100 can prioritize amongst a plurality of issues faced by a member and address clinically efficacious actions, including the most clinically efficacious action, for a member at any given time. In certain embodiments, a final set of logic and business rules may be applied to determine how the recommendations are presented to and experienced by a member. The logic and business rules may be dependent on principles of engagement and the capabilities and design of the systems interfacing with users.

A primary input 104 into the personalization engine 102 is a member condition table having data including diseases information, care pathway stages, non-pathway conditions and risk factors that are relevant to actions that can be served up to a member. The member condition table may pull information from claims data, HRA, electronic medical record (EMR), may be self-reported, or any other suitable source of disease data. The member condition table may include health data that indicates that the member is on one or more care “pathways.” A pathway may be a progression of a disease over time including stage specific differential interventional priorities and opportunities to slow, stop or reverse the expected course of the disease if no intervention were to be provided. In certain embodiments, a non-pathway condition may include a disease that does not have a significant temporal component (e.g., appendicitis). One or more member health visions may also be input via input 104. As discussed herein, health visions may include goals or aspirations. A member may input health visions via user interface 114. The health visions may include choosing a goal from a list of predetermined goals (e.g., “I want to see my grandchildren grow up,” “I want to worry less about my health,” “I want to climb two flights of stairs without feeling short of breath,” or other suitable goals), or, in some implementations, by describing the goal in the member's own words. In certain embodiments, the list of predetermined health visions may be compiled by conducting qualitative and quantitative research to determine what motivates people from a health perspective. For example, surveys may be conducted to determine what health visions should be included in a list of health visions offered to a member via user interface 114. The qualitative and quantitative research may be conducted to learn about how people think about their health at the present and over the longer term, how much they are willing to make changes to improve their health, and how confident they are that they could make these healthy changes in the future. Such research would inform a list of health visions and the design of the interventions to achieve the visions.

Examples of health visions may include: “I want to feel well more often,” “I don't want my health issues to prevent me from doing what I want to do,” and “I want to have more energy.” The institution offering health incentives may also provide a set of population health goals via input 104, which may include the average number of sick days taken by its members, how many of its members participate in the health incentive program, quit smoking or other suitable goals. In certain embodiments, an employer may modify the weights associated with pathways, stages, conditions or actions to encourage a member to achieve a health goal.

The member condition table may include variables for diseases, risk factors and health visions. The variables in the member condition table may include health information about a particular member. For example, the variables included in the condition table may include a member's current stage for each of a plurality of care pathways, a variable for the member's wellness group, flags for conditions that are not pathway conditions but are associated with relevant actions, risk factors that relate to specific actions that would not otherwise be served up, and any required condition exclusion factors. The conditions table may be used to associate specific actions with a member's diseases and risk factors.

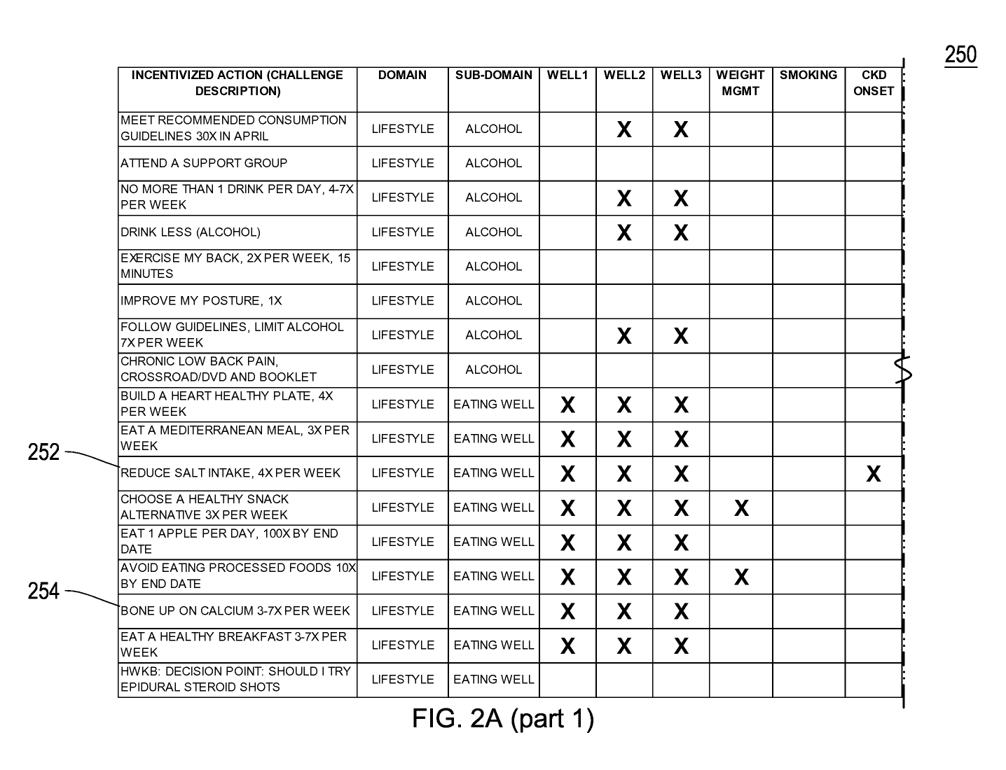

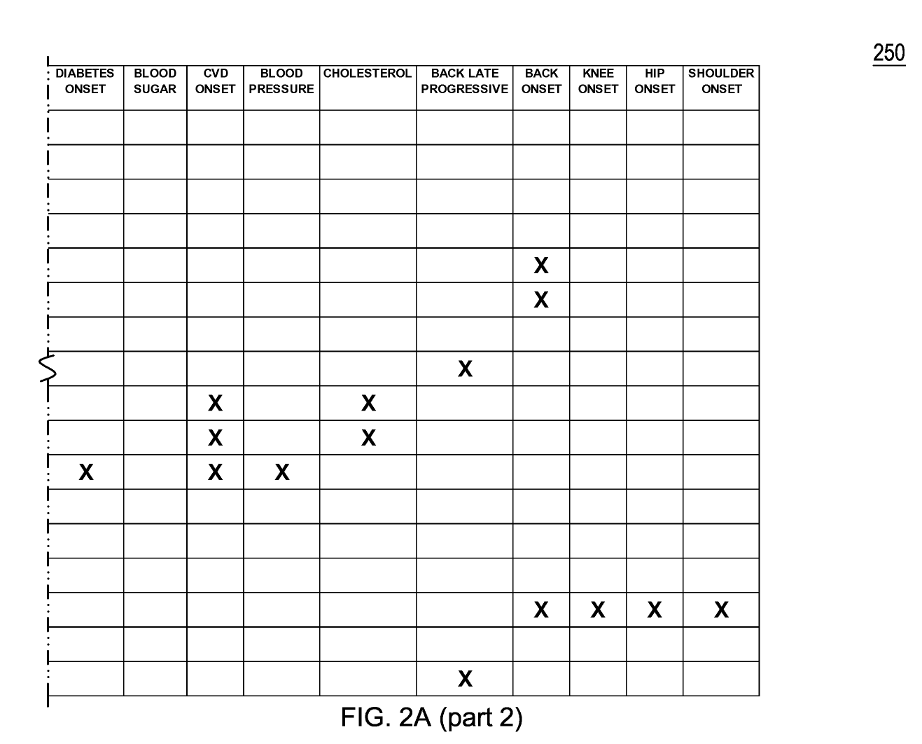

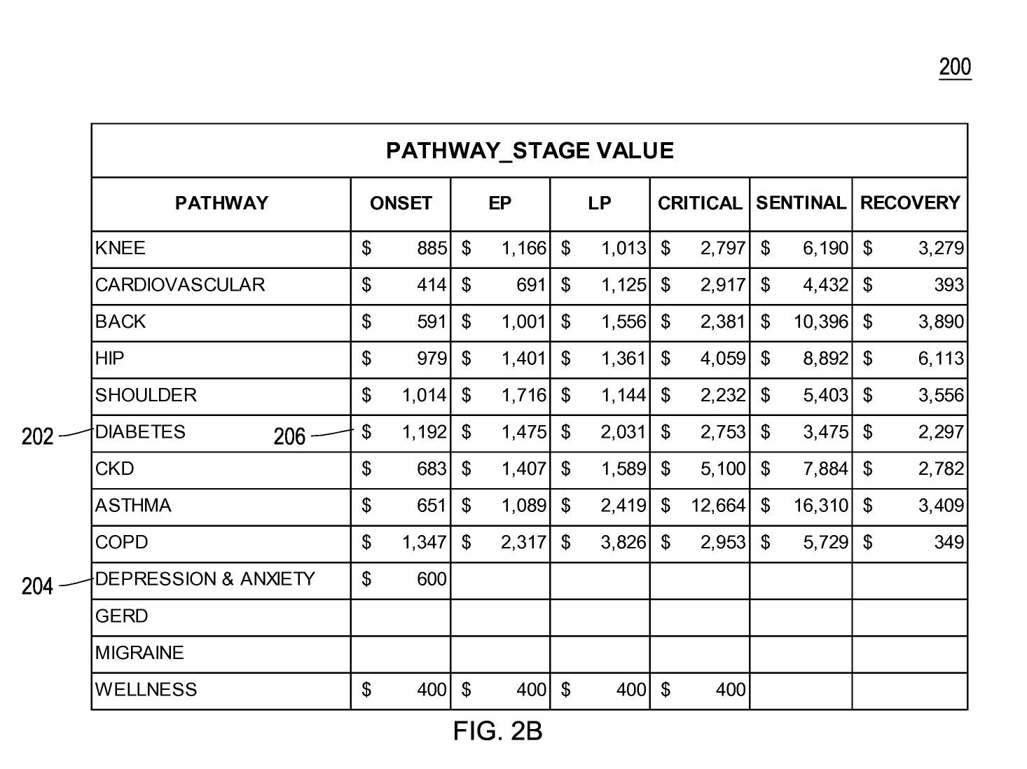

In addition to member condition data included in input 104 to the personalization engine 102, condition specific actions may be input to personalization engine 102 via input 106. The condition specific actions may be stored within personalization engine 102 on computer readable medium, or externally on suitable computer storage equipment. Condition specific actions may include any recommended action that could be served up to members for the purposes of decreasing risk and improving health related to that condition. For example, the action “learn more about the DASH (Dietary Approaches to Stop Hypertension) diet”, could be recommended for any member who was considered in the Wellness 2 or 3 stages and were prehypertensive or who were in the Onset or Early Progressive stages of the Coronary Artery Disease pathway. Each action may have a particular attribute related to a condition and/or stage of disease related to the condition. The condition specific actions may be an internal list stored within the personalization engine system 100, or may be provided by an external source. For example, FIG. 2A shows an illustrative example of an actions table 250. Table 250 includes a list of actions (in the rows of table 250) corresponding to an attribute related to a disease, a disease stage or health risk grouping (in the columns of table 250). For example, for the wellness groupings (i.e., Well1, Well 2 and Well3), CKD onset, Diabetes Onset, CVD Onset, and Blood Pressure, the action 252 “Reduce salt intake 4× weekly” is recommended. For the wellness groupings, Back Onset, Knee Onset, Hip Onset and Shoulder Onset, the action 254 “Bone Up on Calcium 3-7× per week” is recommended. In certain embodiments, the actions table can be configured to serve up content from different content vendors and/or could serve up actions provided by specific mobile health application vendors. It will be understood by those having skill in the art, that table 250 may include many more or less rows of actions and many more or less columns of disease stages. In certain embodiments, the actions may be matched with different attributes related to a disease, disease stage or health risk grouping, or the matching may be dynamically changed in response to new data.

Input 106 may include action level meta-data and a series of reference tables used for weighting actions. The actions table 250 may serve as a mechanism for associating actions with an attribute related to a disease, a disease stage or health risk grouping. For each action that can be served up, the specific actions table may have a series of variables that correspond to attributes of the action. These attributes mirror the variables that are found on the member condition table. The member condition table and the specific actions table 250 may be joined based on common attributes resulting in a series of actions that are relevant to a member. Through the association of diseases and action attributes, and the clinical principles behind the assignment of these associations, a personalized action plan can be created for a member.

A third possible input 108 to personalization engine 102 includes clinical weighting data. The clinical weighting data may be stored as part of personalization engine system 100 or may be received from an external source. The clinical weighting data may include pathway stage data. For example, a pathway stage value table may include pathway stage data for inputting to personalization engine 102. FIG. 2B shows an illustrative example of possible pathway stage data in pathway stage value table 200. Pathway stage value table 200 includes a monetized value for each disease and each stage of a disease. For example, for the “Diabetes” pathway 202, each pathway stage (“Onset,” “EP,” “LP,” “Critical,” “Sentinel,” and “Recovery”) includes a monetary value. The values may be calculated according a selected algorithm. For example, the monetary values may represent the average 12-month cost associated with each pathway and stage. In certain embodiments, the values may be used to estimate a member's future medical costs. For example, when a member has multiple conditions, the cost may be estimated as the sum of each pathway/stage specific cost. In certain embodiments, the patient level total can be used to assign total engagement value and potentially guide the relative size of an incentive package. For example, a individual who was in the wellness-1 category may be offered a series of actions which have a total incentivized value of $400. Another individual who is in the diabetes onset stage 206 may be offered a series of actions which have a total incentivezed value of $1,192. When a member has multiple diseases, the values may be used to weigh the relative importance of each condition to the personal total health. These individual values may also be used to assign value to individual actions (e.g., interventions). In certain embodiments, stage specific cost may be replaced by “impactable” cost. The algorithm for calculating the values in pathway stage value table 200 may be modified at any time.

In certain embodiments, the monetary values may be used by an employer to determine how much to spend on incentivization for performing the actions in an action plan. In certain embodiments, the monetary values represent the spend for each disease stage for individuals. When the values are totaled for a population, the monetary values represent the spend on a population. In certain embodiments, customers and/or employers can use this information as a reference for allocating incentivization resources. Furthermore, customers and/or employers may use this information as a guide to focus on stages of disease progression (e.g. early prevention, primary prevention, secondary prevention) or they can use the information to focus on specific conditions or disease stages (e.g. onset back pain).

It will be understood by those having skill in the art that table 200 is exemplary and the type/number of stages and pathways and corresponding monetary values may be varied. In some embodiments, only monetary values for certain stages are reasonably determinable and included in the table. For example, for the “Depression & Anxiety” pathway 204, only the “Onset” stage includes a monetary value ($600).

The values contained in table 200 may be used by the personalization engine 102 to help assign total possible values for all actions associated with a member's disease. For example, the total value (unadjusted by any down-stream process such as vision weighting or customer weighting) would be $885 for knee onset and $1,166 for knee early progression. That is to say, that the member could have up to this many incentivized points for actions related to his or her knee condition dependent on the member's disease stage. The values in table 200 may be used as an optional weighted input to personalization engine 102. The values in the table 200 may be derived using an analytic process including looking at an average of the difference between current cost and predicted future cost and the average predicted progression cost of a particular pathway and the stages of the pathway. In certain embodiments, the idealized values for the table 200 would represent the potential impact value of interventions for a member. In certain embodiments, actual cost or predicted cost may be substituted as values in the table 200.

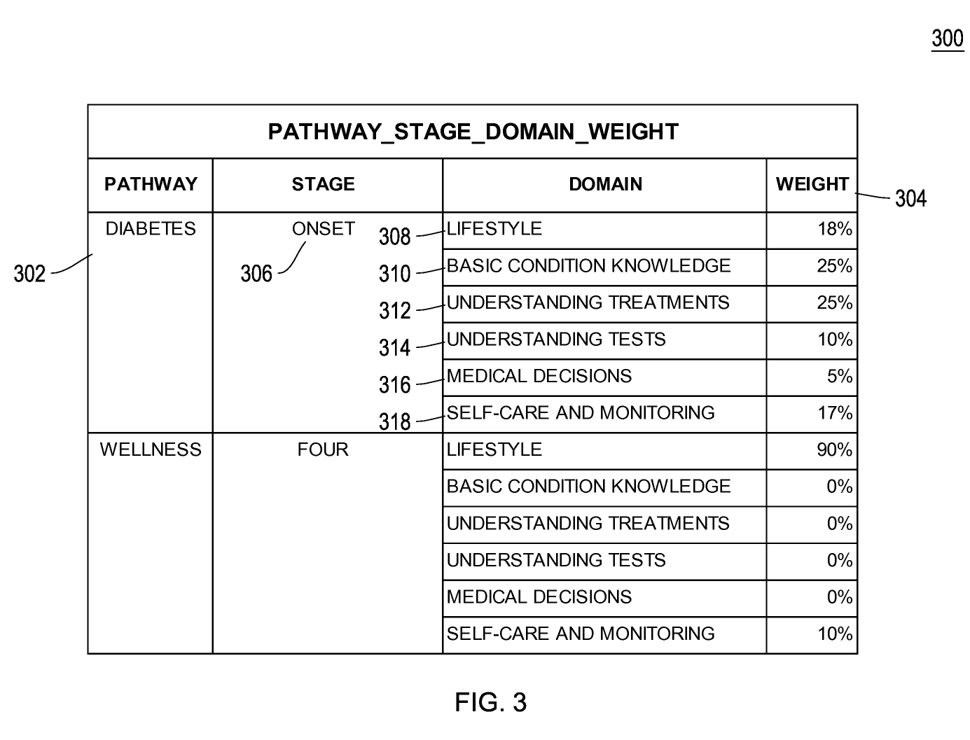

In addition to pathway stage data, the clinical data may include relative domain and sub-domain weighting for each disease pathway in table 200. For example, FIG. 3 shows an illustrative example of possible pathway stage domain weighting data in table 300. Table 300 includes relative weighting for each domain corresponding to a stage of a pathway. For example, in table 300 the “Onset” stage 306 of “Diabetes” pathway 302 (corresponding to onset entry 206 of table 200) includes “Lifestyle” domain 308, a “Basic Condition Knowledge” domain 310, an “Understanding Treatments” domain 312, an “Understanding Tests” domain 314, a “Medical Decisions” domain 316 and a “Self-Care and Monitoring” domain 318. Depending on where a member is in their disease trajectory, the personalization engine 102 may determine whether a particular domain or sub-domain has a higher or lower priority. For example, the domains and sub-domains may be prioritized based on medical best practices, reviews of relevant literature, etc. Each domain 308-318 has a corresponding weight in weight column 304. The weights in column 304 may be updated continuously or periodically based on changing prioritization. It will be understood by those having ordinary skill in the art that the domains and weights listed in table 300 are exemplary and more or less domain entries, different domain data and different weight values may be used.

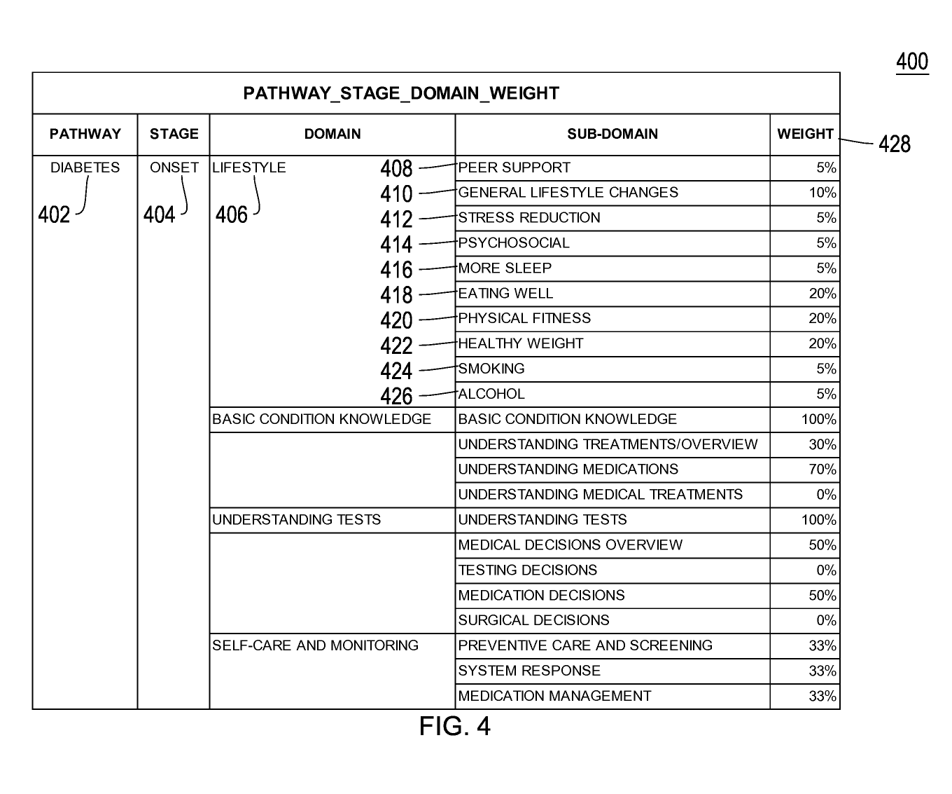

FIG. 4 shows an illustrative example of possible pathway stage sub-domain weighting data in table 400. Table 400 includes relative weighting for each sub-domain corresponding to a domain of table 300. For example, in table 400 the “Lifestyle” domain 406 of the “Onset” stage 404 of the “Diabetes” pathway 402 (corresponding to lifestyle entry 308 of the “Onset” stage 306 of the “Diabetes” pathway 302 of table 300) includes “Peer Support” 408, “General Lifestyle Changes” 410, “Stress Reduction” 412, “Psychosocial” 414, “More Sleep” 416, “Eating Well” 418, “Physical Fitness” 420, “Healthy Weight” 422, “Smoking” 424 and “Alcohol” 426. Each domain 408-426 has a corresponding weight in weight column 428. It will be understood by those having ordinary skill in the art that the sub-domains and weights listed in table 400 are exemplary and more or less domain entries, different sub-domain data and different weight values may be used.

The weights 304 may be applied to a pathway's total value to get a value for each domain. For example, 18% of the $1,192 associated with diabetes onset is determined for lifestyle related actions (i.e. 18%×1,192=215). As a second step in the process, the sub-domain weights 428 may be applied to get the total number of assigned points. For example, 20% of the lifestyle related actions for diabetes onset is determined for physical fitness related actions (i.e. 20%×215=43). Thus, in this example, the maximum number of points assigned to a group of physical fitness related actions specifically related to and appropriate for members in the onset stage of diabetes is 43.

From a technical perspective, both the pathway domain weight table 300 and the pathway sub-domain weight table 400 could be combined into a single reference table as the sub-domain values of table 400 are a sub-setting of the domain values of table 300. In certain embodiments, the tables may be kept separate for purposes of assigning weights and managing the values.

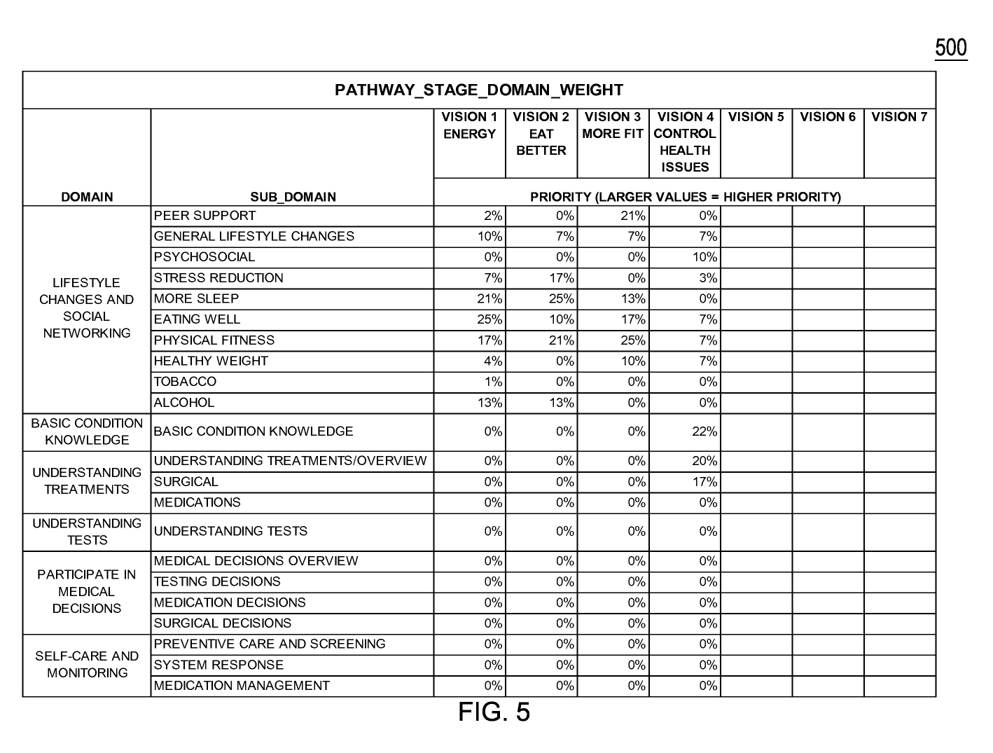

A fourth possible input 110 to personalization engine 102 includes health vision weighting data. The health vision weighting data may be based on health aspirations that a member has for their future health (input by a member as part of input 104). For example, a member may select a health vision from a finite list and the selected health vision may be used by the personalization engine 102 to re-formulate a personalized action plan. For example, certain selected health visions may indicate that a particular domain or sub-domain of a pathway is more important than another, thereby altering the recommended list of member actions 116. For example, two members are identified with the same disease stage, (e.g. diabetes onset). Member 1 selects having more energy while member 2 selects controlling health issues as the vision. For member 1, actions such as eating well, sleep, physical fitness and alcohol will have relatively more weight. For member 2, actions such as basic condition knowledge and understanding treatments will have more weight. In certain embodiments, the health vision weighting data includes data in a table containing the relative weighting of each action sub-domain group for each member health vision. FIG. 5 shows an illustrative example of possible health vision data in vision sub-domain weight table 500. Table 500 contains the relative weighting of each action sub-domain group for each health vision (a.k.a. aspiration). Table 500 may be used as an input 100 to the personalization engine 102 and may modify the clinically derived value points assigned to categories of actions (i.e. domain and sub-domain) based on a member's chosen health vision. The values in table 500 may serve as relative weights which are applied on top of, or sequentially to, the clinically derived weights of input 108. Relative weights may be maintained for each defined health vision. In certain embodiments, weighting based on aspiration may modify the original weights based on clinical objective. Furthermore, an employer may be able to input their priorities via input 128. For example, an employer may feel that back problems are a substantial cause of increased medical expenditure. An employer can configure the pathway stage value table 200 to increase the weight of the onset and early progressive stages of the back pathway. Similarly, an employer may feel that stress is a substantial cause of increased medical expenditure and want to increase the weight of stress reduction in the pathway stage subdomain weight table 400. In this example, actions related to stress reduction, regardless of the medical condition, will be increased in weight (e.g., the role of stress in heart disease, stress reduction and back pain).

Inputs to the personalization engine 102 may be updated continuously or periodically. For example, updates to inputs 104, 106, 108 and 110 may be refreshed each day. The updates may include information from claims, biometric data, electronic health record, vision questionnaire, and health risk assessment. Furthermore, the weighting values in tables 200, 300, 400 and 500 may be updated periodically updated or reassessed, for example, based on new data and business purposes. In certain embodiments, a new action plan may be created by the personalization engine 102 any time one of the inputs changes. For example, if a member selects a new health vision a recalculation of the member's action plan may be triggered.

The personalization engine 102 may generate a personalized action plan 112 based on one or more of the inputs 104, 106, 108 and 110. The personalized action plan 112 may be presented to a member via a user interface 114 and may recommend one or more particular actions 118, 120, 122 and 124 to the member. In certain embodiments, an incentive management tool 128 may add incentives to the personalized action plan 112 and present it to the user interface 114. In certain embodiments, the personalization engine 102 may include a prioritization engine 126. The prioritization engine 126 may be used to organize the display order and/or timing of the actions 118, 120, 122 and 124 on the user interface 114. The prioritization engine 126 may also limit the number of actions to be presented to the user, so as not to overwhelm the member with too many action items. The following is an example of an action plan table that may be generated by the personalization engine 102 for a member who is in the diabetes onset stage and who has selected “Control Health Issues” as a vision. The following example is limited to the “lifestyle” actions generated for a member and does not include potential “non-lifestyle” actions.

The action plan 116 presented to the user may also include incentives related to each action. The incentive management tool 128 may add incentives to each recommended action 118, 120, 122 and 124. In certain embodiments, an incentive may be treated as a pool and allocated to an action at the sub-domain level. For example, in the table above, there is a pool of 82 points around the sub-domain topic of Eating Well. In certain embodiments, the 82 points available for incentivization may be assigned independently or almost independently of a specific action or actions.

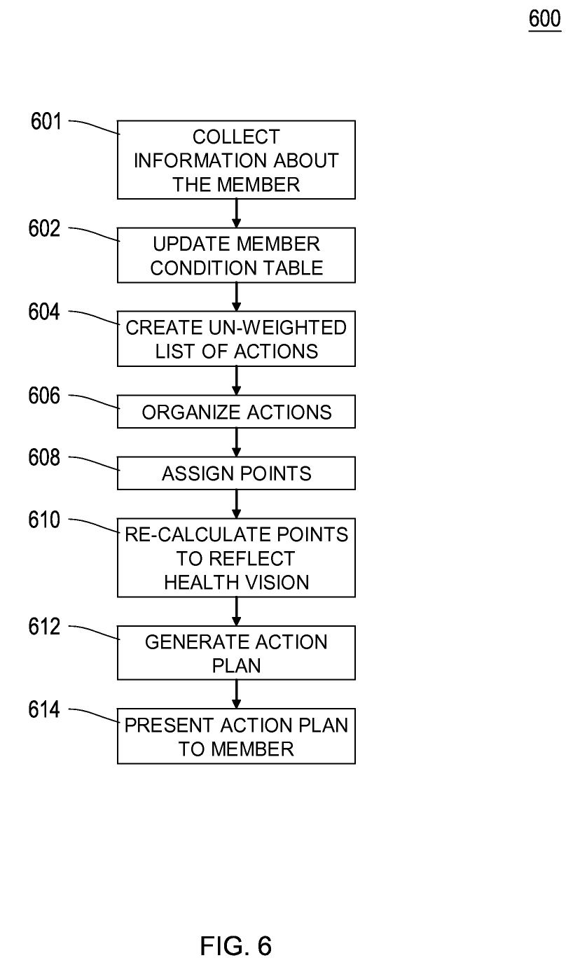

FIG. 6 is a flow chart 600 of an illustrative example of the personalization engine process. For example, the personalization engine system 100 may be used to perform one or more of the steps illustrated in flowchart 600. In step 601, information is collected about a member. The information collected in step 601 may include data about the member's diseases, risk factors and/or health aspirations. For example, member data based on health insurance claims, electronic health data, personal health records, risk assessments, physician data, or other relevant health data from various different sources may be collected in step 601. In certain embodiments the data may be collected from an external source. In certain embodiments, the member may input the data via user interface 114. In certain embodiments, the member may input health aspiration data in step 601. In step 602, the member condition table is updated with the data collected in step 601, including member diseases, risk factors and health aspirations. In certain embodiments, step 602 is performed after a member enters data, for example, health vision data. In certain embodiments, the member condition table may be continuously updated based on data received from an insurance claim or from a physicians' office. In step 604, the member disease data is combined with disease action data to create an un-weighted list of actions. For example, if a user enters data indicating they have five different diseases in various stages of trajectory, the personalization engine 102 may match one or more actions, for example from actions table 250, for each disease in step 604. In step 606, the list of actions are organized by at least one of disease, stage, domain and sub-domain. In step 608, points may be assigned by disease, stage, domain and sub-domain based, at least in part, on data from pathway stage value, pathway stage domain weight and pathway stage sub-domain weight tables. For example, tables 200, 300 and 400, as described above, may be used to assign points. The personalization engine may use tables 200, 300 and 400 to assign points both within a single pathway as well as across multiple different pathways. For example, points may be used to prioritize actions within a single pathway (such as Diabetes), or across multiple pathways, (such as Diabetes, Asthma and Migraine). By assigning points across pathways, the personalization engine 102 can prioritize actions amongst many different ailments so that the most efficacious actions can be performed first. In certain embodiments, a single action can benefit multiple disease conditions and therefore may have additive value for the member's health. The whole person approach used in this system can emphasize the true value of relatively minor actions for persons with multiple diseases. In step 610, data from the member condition table is combined with data from the vision sub-domain weighting table. For example, data from table 500, as described above may be combined with data from the member condition table. In certain embodiments, the personalization engine 102 may perform an internal weighting calculation process using data from the member condition table and data from the vision sub-domain weighting table to recalculate points to take into account a member's self-selected health vision. Based on the member's selected health visions, and the health vision weighting algorithm stored in table 500 and other appropriate information, the personalized action plan may be altered to better suit a member. In step 612, an action plan 116, including one or more actions 118, 120, 122 and 124, is generated by combining one or more of the disease, domain and sub-domain points with the member's disease, domain and sub-domain actions. In step 614, the action plan is presented to the member through a user interface 114. In certain embodiments, the action plan may be presented according to particular business rules such as principles of member experience, a member's consumer history or behavioral patterns and behavioral changes. It will be appreciated by those having skill in the art that the steps of process 600 may performed in an order other than described above, in addition one or more steps may not be performed at all.

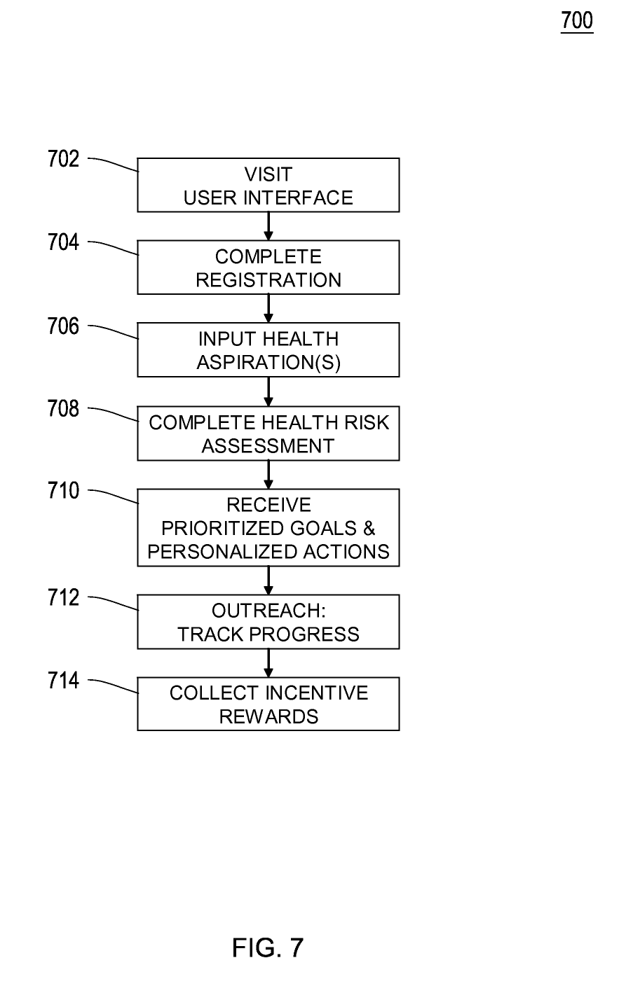

FIG. 7 is a flow chart 700 of an illustrative exemplary process for using the personalization engine system 100 from the perspective of a member. To begin, in step 702, a user may visit a user interface, such as user interface 114 as described with respect to FIG. 1. The user interface may be a web portal, a smart phone app, an in-store kiosk or any other suitable user interface known to those of skill in the art. The user interface may require the user to input log-in credentials such as a user name and a password. Once connected to the user interface, the user may be prompted to complete a registration process in step 704. The user may input basic information, such as health plan, address, telephone number, email address, age, etc. as part of the registration process. In certain embodiments, the user may be prompted to complete a standard opt-in where a user agrees to share information and receive follow-up communication.

In step 706, the user is prompted to input a health aspiration. The user may select a health aspiration from a pre-defined list or may enter their own health aspiration. For example, the user may select “I want to improve my fitness generally, or reach a specific fitness goal,” from a list of 20 health aspirations. In certain embodiments, the user may select more than one health aspiration. In certain embodiments, the user may select no health aspirations.

In step 708, the user is prompted to complete a health risk assessment. For example, the user may answer one or more questions relating to his or her health, or may enter ailments that they are currently suffering from. The data collected from the health risk assessment may be used by the personalization engine to determine what “pathways” the user is on. For example, after completing the health risk assessment in step 708, it may be determined that the user is overweight, sedentary, suffers from knee pain, a poor diet and is unhappy at work. In certain embodiments, the data collected from the health risk assessment may be combined with external data such as information from an insurance company, information from a primary care physician, medical records, medication history from a pharmacy, claims data, biometric screening, etc. to determine the pathways that a user is on, and what stage of any ailment(s) the user is currently in. Furthermore, employer goals may be included by the personalization engine to reduce medical costs, increase employee engagement and participation in health programs, increase productivity and encourage a healthy culture. After completing the health risk assessment in step 708, the personalization engine may generate personalized goals and an action plan. The personalized goals and action plan may be output to the user interface and presented in a prioritized manner to the user. In certain embodiments, the personalized goals and action plans are based on internal algorithms and weights, as described above with respect to FIGS. 1-6. The personalized action plan may focus on helping the user improve his or her fitness level in a way that is safe for his or her diabetes and knee. For example, the user may receive the following prioritized goals: “lifestyle changes” including “peer support,” “physical fitness” and “eating well;” “Basic Condition Knowledge;” and “Self-Care and Monitoring,” including “preventative care and screening.” The user may also receive personalized actions during step 710. The personalized actions may be based on the prioritized goals. For example, a personalized action may be “Participate in a Team Fitness Challenge,” or “Eat at Every Meal.” The personalized action plans may be different for each individual and driven by the individual's health risks. In some embodiments, even if two people were to provide the same aspirational goals and worked for the same employer, each individual may get a different set of recommended actions tailored to each individual and related to their current health conditions. For example, one individual might get a recommendation to run a 5K and earn 50 points toward a $100 gift card. The other individual might get a recommendation to walk 10k steps a day for 2 weeks, and earn 200 points toward the same reward. In a retail setting, the individual may receive customer loyalty point toward discounts on relevant products (e.g., exercise equipment, nicotine replacement products, etc.) if the member completes specific actions in the action plan.

In certain embodiments, the personalized actions may be coupled with incentive points which can be added up and used toward a reward. For example, a gift card or reduction in insurance premiums could be offered as a reward for earning a certain number of points. In certain embodiments, employers can customize rewards such as giving comp time, a retail organization could give loyalty points, and there could also be specific tangible items, such as Fitbits, iPads, or vacation rewards. Incentives may be designed to be so that people would continue and adopt the new healthy behaviors even after the specific incentive ended.

In step 712, the user may receive outreach through one or more channels and track his or her progress in performing the personalized actions and working toward the prioritized goals. In certain embodiments, the personalized action plan is interactive. For example, the user may receive ongoing text messaging support and email reminders that follow the user's progress and encourage completion of action items. The user may check off completed actions via the user interface 114 and monitor progress toward one or more goals. In certain embodiments, the user may answer question on a daily basis regarding whether they completed an action item. For example, the user may be asked whether they avoided sugary drinks for a given day. In some embodiments, outreach may include one-on-one support by a health coach. In certain embodiments, the outreach may be tailored based on an individual's preferred method of outreach, e.g., text message, email or phone call. In a further embodiment, if the user does not engage with the system within a specific timeframe, the user would receive reminders to continue on his or her plan. The user may also monitor how many incentive points they have collected. In step 714, the user may collect incentive rewards. For example, the user may collect gift cards, comp days, tangible items such as Fitbits and iPads, loyalty points, retail discounts and other relevant rewards.

If a user would like to receive another action plan or tackle another health goal, the user may return to the user interface and repeat process 700 as many times as desired. In particular, steps 710-714 may be repeated continuously (e.g., daily, weekly or monthly) as a user completes actions and returns to the user interface to receive more prioritized goals and personalized actions. In certain embodiments, as actions are completed, incentives may be changed. For example, the value of an incentive may increase as a user completes more actions in a personalized action plan. The user may also alter their health aspiration or health risk assessment responses as they choose. It will be understood by those having ordinary skill in the art that the steps of flow chart 700 may be performed in any order. In certain embodiments, one of more steps of flow chart 700 may not be performed at all.

In certain embodiments, a healthcare provider may use data collected by the personalization engine 102 to make recommendations to user regarding certain health programs and products. For example, if it is determined that the user is a smoker, a healthcare provider could offer a smoking cessation program as one of the action items in the list action items 116. As part of the outreach step 712, a smoking cessation program could provide periodic text messaging support with motivation for quitting, reminders why the patient is trying to quit and tips for continuing with the smoking cessation program. In certain embodiments, a user could be introduced to the smoking cessation program through a referral by their physician or at the recommendation of a retail pharmacist. The pharmacist or the user interface 114 may collect specific information about the user's smoking habits, reason for quitting, and desired quit date, and then would provide a quit action plan using the system 100. The user may track progress through the user interface 114 and could receive specific rewards and incentives that support smoking cessation. In certain embodiments, the action plan 116 may include suggested products or actions such as speaking to a physician or other support staff. In certain embodiments, the action plan 116 may be augmented by personal support from a pharmacist or coach trained in smoking cessation techniques. For example, a user may be directed to discuss steps to stop smoking with a coach, including discussing personal triggers for smoking. The coach may use information they know about an individual to provide the support to help them quit smoking

In certain embodiments, a provider may refer an individual to a company providing the smoking cessation program. In some embodiments, members of a company's wellness and loyalty program may be offered the smoking cessation program as a way to quit smoking Depending on the member's status in the wellness and loyalty program, incentives for completed actions may be offered and/or modified. Members may accumulate points in the wellness and loyalty program by purchasing smoking cessation products from the company or by completing actions in a personalized action plan 116.

In certain embodiments, the smoking cessation program may consist of a number of actions across all of the subdomains. The smoking session program may be configured based on a person's pathway stage and comorbidities. For example, a person with heart disease may be given information about the effects of smoking on the heart and the interaction with heart and blood pressure medications. A person with diabetes may be given information about how smoking effects blood sugar control and kidney function. A woman who is pregnant may get information about the effects of smoking on pregnancy and fetal development. Someone who was depressed may get information on smoking and depression. Also, someone with multiple chronic diseases could receive a larger incentive for quitting smoking as compared to an individual without any chronic diseases.

As another example, the personalization engine 102 may make recommendations to a user regarding a weight loss program. For example, if it is determined that the user is overweight, following a weight loss program may be one of the action items in the list action items 116. As part of the outreach step 712, a weight loss program could provide periodic text messaging support with motivation for losing weight, reminders why the patient is trying to lose weight and tips for continuing with the smoking cessation program. The action plan related to the weight loss program may recommend products, physical action, education and other actions to encourage weight loss.

As another example, a healthcare provider could offer a blood sugar monitor to members having diabetes. Based on their pathway and disease trajectory, the healthcare provider could suggest blood sugar monitoring plans and lifestyle changes as part of an action plan 116, in addition to offering related products and other services for sale. For example, a health provider may suggest home monitoring with a health coach program as part of an action plan.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

It will be apparent to those of ordinary skill in the art that methods involved in the present invention may be embodied in a computer program product that includes a computer usable and/or readable medium. For example, such a computer usable medium may consist of a read only memory device, such as a CD-ROM disk, conventional ROM devices, or a random access memory, a hard drive device or a computer diskette, a flash memory, a DVD, or any like digital memory medium, having a computer readable program code stored thereon.

Persons skilled in the art will appreciate that the various configurations described herein may be combined or separated without departing from the present invention. It will also be recognized that the invention may take many forms other than those disclosed in this specification. Accordingly, it is emphasized that the invention is not limited to the disclosed methods, systems and apparatuses, but is intended to include variations to and modifications thereof as understood by those skilled in the art with respect to the following claims.

What is claimed is:

1. A computer-implemented method for creating a personalized health program, comprising:
receiving information about a member;
updating a member condition table with the information;
creating a list of actions by combining the information in the member condition table with disease action data;
organizing the list of at least one action;
generating an action plan including the at least one action; and
presenting the action plan to the member.

2. The method of claim 1, wherein organizing the list of at least one action comprises assigning points to prioritize the at least one action.

3. The method of claim 2, wherein receiving information about a member comprises receiving at least one health vision from the member.

4. The method of claim 3, wherein the health vision is selected from a list of health visions.

5. The method of claim 4, further comprising re-calculating the points to account for the health vision.

6. The method of claim 1, wherein generating the action plan comprises associating at least one incentive with the at least one action.

7. The method of claim 1, wherein the at least one action comprises a personalized health challenge.

8. The method of claim 1, further comprising receiving a population health goal; and
generating the action plan based, at least in part, on the population health goal.

9. The method of claim 1, wherein information includes at least one of claims data, a health risk assessment data, and biometric data.

10. The method of claim 8, wherein the population health goal is to reduce the medical costs associated with a plurality of employees or members of a health plan.

11. The method of claim 8, wherein the population health goal is to increase the number of employees or members who participate in a health program.

12. The method of claim 8, wherein the population health goal is to increase the productivity of the plurality of employees or members.

13. The method of claim 6, wherein the at least one incentive is a gift card.

14. The method of claim 6, wherein the at least one incentive is a reduction in a health care premium.

15. A system for providing a personalized health program, comprising:
a personalization engine configured to:
receive a member condition table comprising member health data, receive condition specific actions,
identify a list of at least one disease based on the member health data and associate at least one condition specific action with the at least one disease, and
output a list of at least one personalized action, and
a user interface coupled to the personalization engine for accepting input data from the member, and presenting the at least one personalized action to the member.

16. The system of claim 15, wherein the personalization engine is further configured to receive at least one health aspiration.

17. The system of claim 16, wherein a user chooses the at least one health aspiration from a list of health aspirations presented on the user interface.

18. The system of claim 15, wherein the personalization engine is further configured to receive clinical weighting data.

19. The system of claim 18, wherein the clinical weighting data is used by the personalization engine to weight the relative importance of a plurality of disease stages.

20. The system of claim 15, wherein the personalization engine periodically monitors member health data and updates the list of at least one disease based on new member health data.

21. The system of claim 15, wherein the personalization engine further comprises a prioritization engine for prioritizing the list of at least one personalized action.

22. The system of claim 21, wherein the prioritization engine prioritizes the list of at least one personalized action by emphasizing a more clinically efficacious action over a less clinically efficacious action.

23. The system of claim 15, further comprising an incentive management tool configured to associate at least one incentive with each of the at least one personalized actions.

24. The system of claim 15, wherein the list of at least one personalized action comprises at least one action related to a smoking cessation program.

25. The system of claim 15, wherein the list of at least one personalized action comprises at least one action related to a weight loss program.
